(19) United States
(12) Patent Application Publication
(10) Pub. No.: US 2008/0151369 A1
(43) Pub. Date: Jun. 26, 2008

(54) LENTICULAR DISPLAY WITH A THREE DIMENSIONAL OPTICAL MAT

(76) Inventor: Stephen R. WELCH, Lisle, IL (US)

Correspondence Address: WINSTON & STRAWN LLP;PATENT DEPARTMENT, 1700 K STREET, N.W., WASHINGTON, DC, 20006, US

(21) Appl. No.: 11/941,730

(22) Filed: Nov. 16, 2007

Related U.S. Application Data
(63) Continuation-in-part of application No. 11/429,554, filed on May 5, 2006.
(60) Provisional application No. 60/866,489, filed on Nov. 20, 2006.
(60) Provisional application No. 60/738,346, filed on Nov. 18, 2005.
(60) Provisional application No. 60/678,366, filed on May 7, 2005.

(51) Int. Cl. G02B 27/22

(52) U.S. Cl. 359/463

(57) ABSTRACT

The present invention provides a lenticular display that provides the perception of depth to the viewer, by printing a substantially opaque mat or border around an image which creates a three dimensional appearance or bevel affect. An additional image is printed within a portion of the mat which is not substantially opaque. The images and mat are printed simultaneously on the same planar surface of the lenticular sheet, and provide the visual affect of a raised mat which aesthetically enhances the image. The lenticular display is removably positioned within a housing that encompasses the periphery of the lenticular sheet and can be mounted to a wall, container, stand upright. An electroluminescent panel may be provided within the housing to provide greater visibility and an enhanced appearance to the image.

### CROSS REFERENCE TO RELATED APPLICATIONS

This application claims the benefit of provisional application No. 60/866,489 filed Nov. 20, 2006 and is a continuation-in-part of application Ser. No. 11/429,554 filed May 5, 2006, the latter of which claims the benefit of provisional applications Nos. 60/738,346 filed Nov. 18, 2005 and 60/678,366 filed May 7, 2005. The entire content of each earlier filed application is expressly incorporated herein by reference thereto.

### BACKGROUND OF THE INVENTION

The present invention is directed to a picture or object display that provides a depth image to the viewer and, more particularly, to a lenticular display that allows a user to view an image having a border that creates a three dimensional appearance or bevel affect, while maintaining a planar, two dimensional configuration of the image and border.

A typical picture frame is formed having an edge molding of a rectangular shape with mitered corners and a sheet of transparent glass or plastic, mounted under an edge lip on the molding. A mat having standard thickness of 0.25 to 0.125 inches is positioned under the transparent sheet of glass so as to create a gap be between the image and the exterior glass. The mat contains a cutout center portion for viewing the artwork, such that the cutout creates a bevel along the sides which define the center portion of the mat. Usually a non-porous backing and a stiff backing are positioned behind the artwork within the frame molding. The glass, mat, artwork, and backing can be held in place within the molding using small nails or the like to hold the framed artwork together. A hanger is typically added to the frame which may consist of screw eyes on two sides of the edge molding connected by a hanging wire. Thus the traditional picture frames have actual physical depth with the mat providing three dimensional characteristics in the form of beveling or molding. This perception of depth enhances the aesthetic appeal of the image being displayed.

This conventional frame suffers from several disadvantages in that the assembled frame can be quite heavy, making mounting of the frame difficult, and the glass exterior often creates a glare which obscures the image. Additionally, the setting of the mat and artwork demands a high degree of skill and expertise, thereby requiring a professional to perform the assembly which increases cost.

The production of image displays to create a three dimensional affect by employing lenticular lenses is known and described in detail in U.S. Pat. No. 5,720,123 to Taylor and U.S. Patent Application Publication No. 20040261938 to Bradford. In general these references disclose displaying an image in a frame, wherein the frame itself is a three dimensional lenticular frame that surrounds a two dimensional image image. However neither of these references teach printing a three dimensional mat affect on a planar or two dimensional image, which is the aim of the present invention.

A backlit display device for automatic viewing of lenticular images cards is known and describe din detail in U.S. Pat. No. 6,574,047 to Hawver. In general this reference disclose displaying an image in a frame, wherein a lamination source directs light through the lenticule side of the lenticular image card in conformance to the card's view distance and selected viewing angle to sequentially illuminate each image in turn. However, this reference does not teach moving the lenticular sheet to generate a sequence of images, which is a particular aim of the present invention.

Moreover, a common method of forming lenticular displays is by printing the image onto a substrate, and attaching the substrate to the lenticular with the use of adhesives, however this configuration is undesirable in that it is prone to distortion of the image. Given that the plurality of lenticules have a focal point of a predetermined distance on the rear flat side of the lens where the image is mounted, an adhesive layer disposed between the lenticules and the image has an inherent thickness which increases the spacing of the image and lenticule beyond the predetermined focal point of the lenticules. This results in ghosting or crosstalk distortion between the images, which is a phenomenon that occurs when the viewer sees two or more images at the same time from a single viewpoint of a lenticular image. It is therefore important to have intimate contact between the lens and image for high quality images.

Thus there is a need in the art for enhanced lenticular displays that overcome the problems and deficiencies of the prior art and these are now provided by the present invention.

### SUMMARY OF THE INVENTION

The invention relates to a lenticular display comprising a lenticular sheet having a plurality of lenticules and a rear surface; at least one image positioned adjacent to the rear surface of the lenticular sheet which is viewed through the lenticular; and a conveyer system for changing the at least one image. When illumination is desired, the display preferably comprises an electroluminescent panel to illuminate the at least one image for display.

The at least one image can be printed on a separate sheet which is moved by the conveyer to change the at least one image. Alternatively, the at least one image may be printed on the lenticular sheet, and the lenticular sheet moved by the conveyer to change the at least one image.

The invention also relates to a lenticular display comprising a lenticular sheet having a plurality of lenticules and a rear surface; a plurality of interlaced images positioned adjacent to the rear surface of the lenticular sheet; and an electroluminescent panel to illuminate the image(s) for display; wherein the interlaced images are individually viewable at a different angles with respect to the display and comprise commercial advertising of one or more products. The images can display a sequence of images relating to one product, or different images can display different products. In addition to printing the images on a separate sheet or on the lenticular, the images may be printed directly on the electroluminescent panel. Preferably, the images have a resolution of between 300 dpi and 800 dpi. If desired, the images can provide the appearance of movement.

The invention also relates to a lenticular display comprising a lenticular sheet having a plurality of lenticules and a rear surface; one or more image(s) printed on a first display region of the rear surface of the lenticular sheet; a substantially opaque border printed on a second display region of the rear surface of the lenticular sheet surrounding the first display region; and a housing supporting the lenticular sheet; wherein the opaque border provides the appearance of a raised mat around the image(s) on the first display region. Advantageously, the second display region includes at least one interlaced image printed therein, wherein a substantially opaque third display region is printed on the rear surface of the lenticular sheet between the first and second display regions, so as to create a bevel affect between the first and second display regions to further enhance the appearance of the border. Preferably, the lenticular display further comprises an electroluminescent panel that illuminates the image(s) to provide greater visibility and an enhanced appearance to the image(s).

The invention also relates to a combination comprising a lenticular display that includes a lenticular sheet having a plurality of lenticules and a rear surface; at least one image printed on a first display region of the rear surface of the lenticular sheet; and a vehicle that includes a support for mounting the sheet and images, so that the display can be transported and viewed during movement of the vehicle. If desired, the lenticular display can include an electroluminescent panel that provides backlight illumination of the display, with the panel powered by a battery. In this arrangement, the electroluminescent panel may also be operatively associated with a sensor that detects darkness or motion for powering the panel only when movement or darkness is sensed by the sensor. As above, the at least one image comprises a plurality of interlaced images which are individually viewable at a different angles with respect to the display.

### BRIEF DESCRIPTION OF THE DRAWINGS

FIG. 1 is a cross sectional view of a lenticular sheet having interlaced images printed on a rear surface.

FIG. 2 is a top view of the lenticular display defining the three display regions of the lenticular sheet.

FIG. 3 is a cross sectional view of the lenticular display mounted within the housing.

FIG. 4 displays a conveyer moving lenticular images across a electroluminescent panel.

### DETAILED DESCRIPTION OF THE PREFERRED EMBODIMENTS

One embodiment of the invention relates to a lenticular display that provides the perception of depth to the viewer, by printing a substantially opaque mat or border around an image which creates a three dimensional appearance or bevel affect. An additional image is printed within a portion of the mat which is not substantially opaque. The images and mat are printed simultaneously on the same planar surface of the lenticular sheet, and provide the visual affect of a raised mat which aesthetically enhances the image. The lenticular display is removably positioned within a housing that encompasses the periphery of the lenticular sheet and can be mounted to a wall, container, stand upright. An electroluminescent panel may be provided within the housing to provide greater visibility and an enhanced appearance to the image.

Preferably the image(s) and the border are printed on the rear surface of the lenticular sheet simultaneously. Further, it is desirable to print at least one interlaced image within the second display region.

Advantageously, a substantially opaque third display region is printed on the rear surface of the lenticular sheet between the first and second display regions, so as to create a bevel affect between the first and second display regions to further enhance the appearance of the border.

In another embodiment, an electroluminescent panel which serves to illuminate the image(s) and provide greater visibility and an enhanced appearance to the image(s), can be either enclosed within the housing, or affixed to the housing. It is further desirable for the housing to be arranged such that it extends around the periphery of the lenticular sheet, thereby exposing the three display regions, and has the lenticular sheet that is removably attached thereto.

Further, in an exemplary embodiment, the housing is a picture frame which includes a member that enables the frame to stand upright on a flat surface. Additionally, it is desirable for the housing to be affixed to an article such as a container, cup, mug, thermos, or glass.

Preferably, the image(s) provide(s) a three dimensional appearance, and/or the appearance of movement.

In an alternate embodiment, the housing comprises a backlit lenticular assembly associated therewith, the backlit lenticular assembly comprising a lenticular, an electroluminescent panel for providing backlight, and an image(s) provided between the lenticular and electroluminescent panel, wherein the backlight illuminates the image(s) to provide greater visibility and an enhanced appearance to the image. The image(s) may be provided on either the lenticular or electroluminescent panel, or on a movable support member that is placed between the lenticular and electroluminescent panel.

In another embodiment of the invention, the lenticular display may include a movable conveyer of lenticular image(s), and electroluminescent lamp of the display device is placed in the housing. It is desirable for the housing to have a transparent viewing window adjacent the lenticular and the image(s) is provided on a support and in a manner that periodically rotation and updating of the image(s) and support. In the preferred arrangement, the image(s) are adhered to the support with an optically clear adhesive so that it is removable with the lenticular.

A conveyor belt with advertising providing the desired features may be constructed from the following components. At least one belting member, the belting member has a first predetermined length, an upper surface, a lower surface, first and second parallel side edges and first and second ends. At least one lenticular image is provided. In one embodiment, the lenticular image is placed between the electroluminescent lamp and the lenticular sheet. Alternatively, the lenticular sheet moves with the lenticular images through the conveyor system.

In another embodiment of the present invention, lenticular display contains the images without the opaque border printed on a second display region. The effect of the borderless lenticular display allows for a broader surface area for the images themselves and an apparatus that maybe combined with other lenticular displays in forming a larger image.

A picture frame or object frame is a mechanical device used to display images or objects while providing physical protection, mounting features to retain the image or object, and other members to support the assemblage in its intended viewing location. The use of lenticular images in the construction of a display device increases viewer attraction to the display over conventional displays and can be used with autostereoscopic images to simulate actual physical materials or scenes, and computer-generated image effects causing the image to look different or animated as the viewer changes position relative to the display.

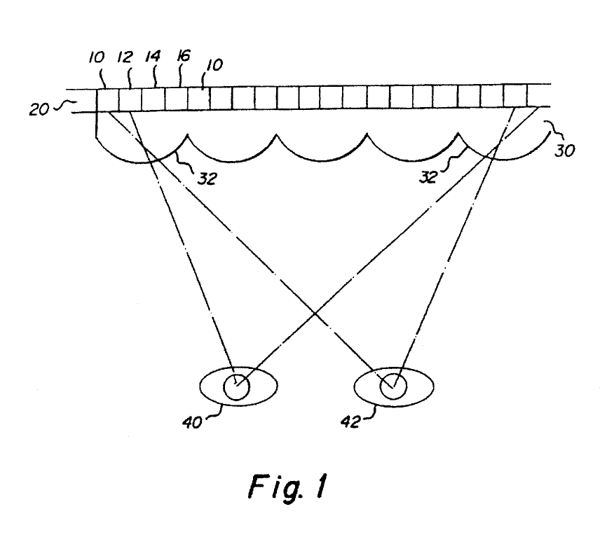

With reference to FIG. 1, a lenticular image or picture is created by capturing or creating a series of images of a scene or object from different viewpoints. Slices or strips 10, 12, 14 and 16 of each viewpoint image are interleaved and printed onto a rear surface of the lenticular sheet 30. The lenticular sheet 30 includes lenticules 32 which are cylindrical lenses generally oriented with the long axis running in the vertical direction of the image. Each lenticule projects a different one of the slices to the eyes 40 and 42 of a viewer. The viewer merges the slices into an integral image that provides a sense of depth because each eye sees a different one of the viewpoint scenes. The lenticular display can be a reflection print which relies on ambient light, or a backlit film transparency which includes an electroluminescent panel providing enhanced visual and optical characteristics and decorative appeal.

Preferably, the lenticules have a dome which is a hemisphere supported on a flat panel. The radius of the dome represents 3 to 10% and preferably 5% of the overall width of the panel and the radius of the dome. For 2D images, printing is accomplished so that every 48 degrees of the dome circumference represents a different image. For 3D images, printing is accomplished so that every 23 degrees represents a different image.

In forming the lenticular sheet, it has been found that any clear, flexible polymer, such as, for example, thermoplastic elastomers, polyvinyl chloride, polypropylene and polyethylene can be employed in the present invention. In those instances where the perception of depth, for example 3-D, or motion, such as animated imagery is sought to be achieved, a lenticular plastic, which is a sheet or layer of plastic that has a series of lenses running along its length, is required. Where the appearance or perception of depth is not needed, the lenticular can be employed for morphing or zoom visual affects. Such lenticular plastics can be made by well-known prior art methods, such as calendaring, extrusion, injection molding, hot pressing, etc., and can be employed in accordance with the present invention. All of these plastics possess certain physical and chemical qualities which make them particularly suitable for use in accordance with this invention. For optimum viewing of the images, the lenticular should be molded rather than mode by made by other technologies. This avoids the problems of flattening of the lenticules during movement when the lenticules are made by extruding or calendering

Lenticular images or pictures are created, as previously discussed by capturing or graphically creating a series of images using a conventional depth image capture or creation device. The images of the object or scene from the different viewpoints are provided to an image processing computer which interleaves the slices of the images to create a lenticular image that is provided to an image printer. The interleaved images are then printed directly onto the rear surface of the lenticular sheet.

When printing the image directly onto the lenticular sheet, the reverse of the desired image, whether it is a depiction of an animal, an athlete, animation, commercial slogan, trademark, etc. is printed on the back or rear surface (20) of the lenticular plastic sheet. In other words the array of interlaced images is printed on the flat surface of the sheet, which is opposite the array of raised cylindrical or hyperbolic lenticules (32). The reverse of any of the foregoing images is imprinted on the back or rear surface of the plastic sheet by means of, for example, lithography, or silk screening. The images can be printed over a wide range of parameters depending upon the desired final appearance. A resolution of at least 350 dots per inch (dpi) or greater is utilized when higher quality images are desired. The images are preferably printed at a resolution of 6400 dpi. Higher or lower values can be used as necessary to convey the desired image. A higher resolution allows for more frames or strips of images to be printed, thus providing enhanced motion simulation. That is, the more frames provided behind the lenticular, the more stages of motion will be viewed as the viewer's perspective changes relative to the lenticular sheet. Additionally it is advantageous to form the lenticular sheet having a range of 20 to 250 lenticules per inch (lpi). It is a preferred embodiment of the present invention to employ a lenticular sheet at the upper limit of this range so as to eliminate the appearance of the bumps or convex lenticules. The higher the lpi, the more dense and minute the raised lenticules, thus the less visible they appear to the naked eye. For larger objects, such as a billboard, lower dpi values are entirely suitable. Typically, 75 to 100 lpi are used for achieving images of good quality.

It is also possible to print the array of interlaced images directly onto an electroluminescent lamp or panel which is provided to illuminate and accentuate the images. First the electroluminescent components such as the cathode, phosphor, anode, etc. are silk screened onto a clear polymeric substrate (e.g. PVC). An example of a conventional method of forming electroluminescent panels is disclosed in U.S. Pat. No. 5,667,417, the entire disclosure of which is incorporated herein, in their entirety, by reference, for all purposes. Commercial embodiments of the electroluminescent panels of this patent are available from E-Light Technologies, Inc., Trumbull, Conn. Next the interlaced graphics of the image(s) are silk screened over the electroluminescent panel employing a four color process (cyan, magenta, yellow, and black).

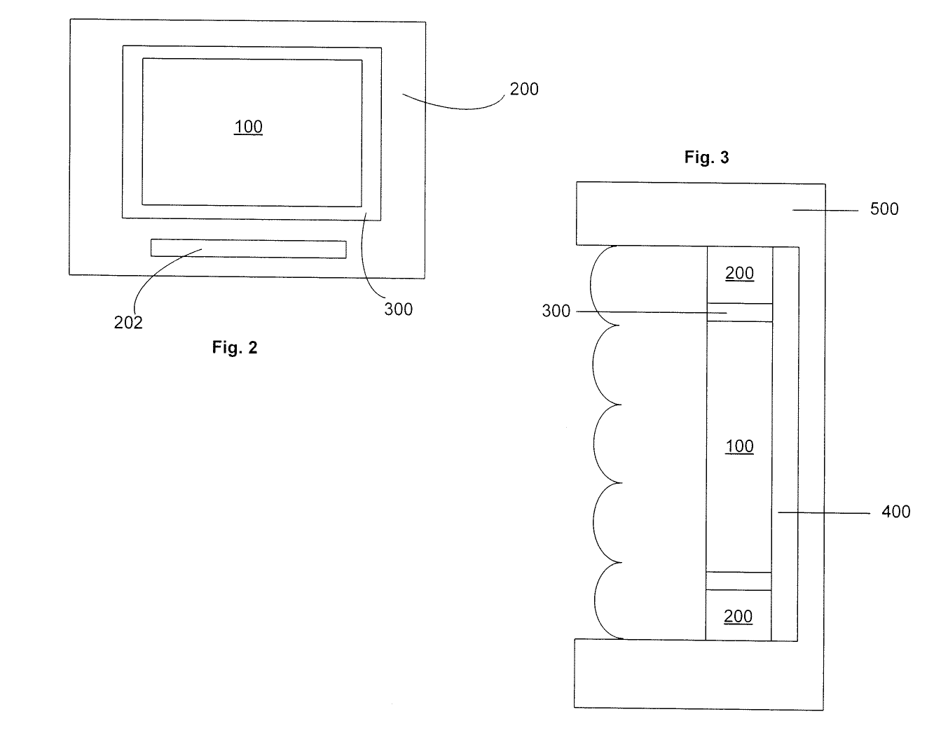

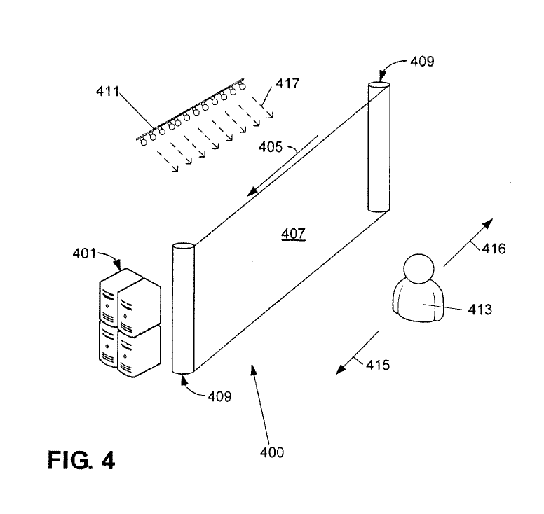

The printing of a three dimensional mat or border surrounding the image will now be discussed in further detail with reference to FIGS. 2 and 3. The array of interlaced images is printed on the rear surface of the lenticular sheet within a first display region (100), which has a substantially opaque border printed on a second display region (200) which extends around an outer periphery of the first display region (100) and provides the appearance of a raised mat around the image(s) of the first display region (100). The second display region includes at least one interlaced image (202) printed therein, which is does not overlap or coincide with the surrounding opaque portion of the region such that image (202) is visible. Typically this interlaced image (202) is positioned either along the bottom or top of the first display region (100) and contains a title associated with the image viewed in display region (100).

Disposed between the first and second display regions is a third display region (300) which creates the perception of depth or distance between the first and second display regions, despite the fact that all images and display regions comprise silk-screened ink which is printed on the same planar surface, i.e. the rear surface of the lenticular sheet. In other words, the third display region (300) creates a bevel affect between the first and second display regions to further enhance the appearance of a raised mat around the image(s) on the first display region. It is preferred that the third display region create the appearance of a quarter inch depth between the first and second display regions, though other depths can be utilized as desired. Typically this third display region (300) will be composed of a different color ink than the second display region (200) to clearly define the boundary of each region and augment the three dimensional affect.

Furthermore, the printing of each region, and the images contained therein, occurs simultaneously. That is to say, the interlacing of the images and configuring of each display region is performed by a computer program, which then prints a single layer of ink to the rear surface of the lenticular sheet. This single step printing method reduces the manufacturing time, and reduces waste, and intimately positions the image(s) on the lenticular so as to avoid morphing due to spacing between the image(s) and lenticule as discussed above.

Additionally, the lenticular display may contain an image printed on the rear surface of the lenticular sheet such that the image appears to move from the first display region (100) to the second display region (200), passing through the bevel or third display region (300), as the viewer's angle of observation changes. An example of this optical affect would be for the first display region (100) to contain a picture of a solar system (having planets, moons, stars, etc.) wherein a star or comet appears to move from the first region (100) across the image and into the optical mat (200) region as a function of the viewer's position or perspective.

The lenticular display of the present invention may also employ a electroluminescent panel (400) of the type described herein to provide illumination of the images and enhanced visual affects. The electroluminescent panel (400) is positioned adjacent to the rear surface of the lenticular sheet (30) and may be either removably enclosed within the housing (500) or can be permanently affixed to the housing (500) with the lenticular sheet (30) remaining interchangeable. The electroluminescent panel (400) serves to illuminate the image(s) within the first display region (100) and the image(s) (202) within the second display region (200) while the opaque portion of the second display region, and third display region (300) remain cloaked by the opaque ink printed therein. The electroluminescent panel (400) may be battery powered, wherein the battery is contained within the housing (500). Alternatively, the electroluminescent panel (400) may be powered by an alternating circuit (AC) which is delivered to the panel in a flat tape electrical cord, such as DUREL. Furthermore, the electroluminescent panel may include a motion detector or photo sensor such that the panel (400) is activated upon movement or ambient light level respectively. These sensors also prolong the service life of the electroluminescent panel as well as the batteries (when used).

The housing (500) extends around the periphery of the lenticular sheet, exposing the display regions. The exposure of the display regions eliminates the occurrence of glare arising from a traditional glass cover frame as discussed above, as well as preventing accidental breaking of the glass during transit. In a preferred embodiment the housing is a picture frame comprising a member that enables the frame to stand upright on a flat surface, or be mounted to a wall. Alternatively, the housing may be pliable to enable configuring (e.g. bending) of the housing in order to be affixed to an article such as a container, cup, mug, thermos, or glass by any suitable means including adhering, sewing, welding, etc.

The present invention also relates to the use of the lenticular displays as disclosed herein, with or without the mat and images interspersed therein, as a display device for displaying one or more removable or fixed images with the display mounted on a building or vehicle. Advantageously, these displays are backlit, preferably with electroluminescent lamps as described herein.

In forming the display, it has been found that any transparent material can be used. While glass is possible, it is not preferred due to its relative brittleness. What is preferred for use in the present invention is a clear, flexible polymer, such as, for example, thermoplastic elastomers, polyvinyl chloride, polypropylene and polyethylene. In those instances where the perception of depth, for example 3-D, or motion, such as animated imagery is sought to be achieved, a lenticular plastic, which is a sheet or layer of plastic that has a series of lenses running along its length, is required. Where the appearance or perception of depth is not needed, the lenticular can be employed for morphing, zoom, or animated visual affects. These lenticulars can be designed to magnify or amplify or even to shrink or compress the image to achieve the desired visual effect. Also, color changes can occur when the lenticular is viewed at different angles, if desired. Such transparent materials and in particular the lenticular plastics can be made by well-known prior art methods. These plastic materials can be made by calendaring, injection molding, hot pressing, etc., and any such process can be employed in accordance with the present invention. As noted herein, molding is preferred for optimum results in dimensional stability in that previously formed domes can be obtained which are superior to those obtained by extrusion.

All of the plastics mentioned herein possess certain physical and chemical qualities which make them particularly suitable for use in accordance with this invention. These qualities are texture or feel, and of particular importance to the present invention, the ability to be washed and dried repeated times without becoming brittle or stiff, as well as optical clarity and printability. The optical properties of these materials is not critical and can be selected by skilled artisans for the particular implementation. A refractive index of between 1.3 to 1.5 is useful for many of the applications described herein.

The image of the lenticular display device may be composed of an array of interlaced images which when viewed through the lenticular lens create the 3-D or morphing affect as desired. This array of interlaced images can be printed directly onto the lenticular sheet, directly onto the electroluminescent panel, or onto a separate sheet which is then removably affixed to the electroluminescent panel or lenticular sheet, each of these methods will be discussed in detail below. Further, it is possible to provide lenticular sheets of varying colors associated with different designated viewing angles. For example, the lenticular device may display a series of colors such as red, white, and blue, as a viewer's perspective moves or changes relative to the lenticular display. All of these are considered to be images in accordance with the invention, and are distinguishable from the single color or clear lenticular of the prior art.

When printing the image directly onto the lenticular sheet, the reverse of the desired image, whether it is a depiction of an animal, an athlete, a cartoon character, commercial slogan, trademark, etc. is printed on the back or rear surface of the lenticular plastic sheet. In other words the array of interlaced images is printed on the flat surface of the sheet, which is opposite the array of raised cylindrical or hyperbolic lenticules. The reverse of any of the foregoing images is imprinted on the back or rear surface of the plastic sheet by means of, for example, lithography, or silk screening. If desired, other types of printing, e.g., ink jet printing, can also be used, if desired.

It is also possible to print the array of interlaced images directly onto the electroluminescent lamp or panel. First the electroluminescent components such as the cathode, phosphor, anode, etc. are silk screened onto a clear polymeric substrate (e.g. PVC). An example of a conventional method of forming electroluminescent panels is disclosed in U.S. Pat. No. 5,667,417, the entire disclosure of which is expressly incorporated herein by reference thereto. Next the interlaced graphics are silk screened over the electroluminescent panel employing a four color process (cyan, magenta, yellow, and black).

There are some applications where the printing directly onto the electroluminescent panel would not be practical because the image would be permanently affixed to the lenticular display. In the interest of increasing the flexibility and range of applications, the array of interlaced images may be silk screened onto a substrate sheet which is then affixed to the lenticular assembly. Preferably, such a substrate or support sheet is made of a thermoplastic or other transparent film. As discussed above, due to the focus point behind each lens of the lenticular sheet, the spacing between the image and the lenticular is critical. As such it is undesirable to affix the image sheet to the lenticular sheet with an adhesive layer since this often adversely affects the visibility of the image by increasing the distance between the lenticular and the image.

Accordingly, when printing the array of images onto a substrate sheet, it is advantageous to employ a series of registration devices (e.g. polls, pins, protrusions, etc.) on the electroluminescent panel for precisely registering the image sheet with the panel. Furthermore, in this embodiment the lenticular sheet is formed with corresponding holes or notches to correspond with the registration devices of the panel, thereby ensuring precise alignment of the panel, image sheet, and lenticular sheet to prevent distortion of the resulting illuminated images.

These printing methods will insure a high degree of clarity and brilliance of color, for example in four color (cyan, magenta, yellow, and black) printing at least 300 dots per inch. Disposing each color at a different angle will serve to provide a living color image without moiré or interference. The printing methods of the present invention provide for each pixel of the image, represented at the optical focal point of the lenticular, to have a photon emitted from the electroluminescent panel which perpendicularly penetrates the pixel thus minimizing the scattering and ghosting of the image. While a skilled artisan can determine the best arrangement for any particular implementation, photon emission from the electroluminescent panel at a distance of between about 10 and 50 microns from the focal point of the lenticular, and preferably from a distance of 20 to 30 microns, has been found to be useful for the embodiments disclosed herein. By providing the lenticular and printed images as disclosed herein in combination with the electroluminescent panels, one obtains a perpendicular projection of all photons through the lenticular for optimum image generation and projection. The resulting image provides the appearance of motion, morphing, flip, or zoom of the image as the viewer's perspective or distance and angle to the lenticular changes.

If desired, a bonding material can be used to adhere the lenticular assembly to the vehicle, building or to another portable and moveable support. Any conventional adhesives can be used for this purpose, Also, the bonding can be made by mechanical means, such as clamps, rivets, screws, bolts and nuts or other conventional attachment mechanisms.

In one exemplary embodiment, it is desirable to display a wide array of images on a particular space to ensure optimal usage of the lenticular display. Accordingly, a movable support in the form of one or a series of conventionally arranged and operated conveyer belts carrying a plurality of image sheets between across one or more electroluminescent panels and the lenticular display, thereby ensuring periodic displaying of multiple images in a sequence. In another embodiment, there may be a plurality of different images printed on the lenticular sheet, depending on the direction and angle of viewing, different images are displayed. Alternatively, images that having a common theme or representing a series of motion maybe printed on the lenticular sheet. As viewed from different angles the lenticular images will generate sequence of motion with a common theme or story. To display additional images on the lenticulars, the lenticular sheet maybe a part of the conveyer belt, periodically scrolling to display various different images.

In another embodiment, the lenticular sheet itself moves with the conveyer system either sequentially, continuously, or sporadically. The images can form part of a common theme or visual story. Such arrangements are highly useful for commercial advertising of related or unrelated products. The images change as the viewer moves with an angular position with respect to the display, or the images can change without movement of the viewer by sequentially or sporadically moving image sheets or lenticulars that contain the printed images.

In another embodiment, the wide array of images may be a sub-portion of a larger image where the series of lenticular displays form a larger mosaic display. It is advantageous that the timing of the images moving across the electroluminescent panels is controlled by a local or a remote computerized system. In one exemplary embodiment, the themes maybe a series of advertisement for a particular product, images representing a common theme or different theme and the like.

Electroluminescent panels are somewhat prone to moisture degradation, which is particularly problematic in the present application of the backlit lenticular which may routinely entail exposure to moisture when displayed outdoors. Therefore the present invention can be enclosed between clear plastic sheets to overcome this vulnerability. To achieve this feature, the electroluminescent panel may be laminated on both sides with a PVC or other polymer layer that extends beyond the border of the panel to form a flange portion which will be bonded to the lenticular and article as will be discussed below.

The flange portion of the polymer surrounding electroluminescent panel protects the electrical elements of the electroluminescent panel (e.g. anode, cathode, phosphor, etc.) and image (i.e. ink) from the elements which otherwise adversely affect the panel and image. Further, the flange portion provides a surface area that can be used to bond or attach the display to a vehicle, building or other support.

In the alternative to forming the backlit lenticular and article as an integral combination which is permanently bonded, a compartment may be formed on, or within, the building, vehicle or other support for receiving the display.

To energize the electroluminescent lamp, a signal is brought by a wiring harness from a pack preferably comprising a battery power source and an electrical inverter. When used on a vehicle, electrical power can be obtained from the vehicle battery. The function of the inverter is to convert direct current to an alternating current known to persons of skill in this art as sufficient to cause the electroluminescent layer to emit light. The pack further comprises a control electronic circuit that determines when the lamp emits light. A simple control can be one that is on on-off switch or one that causes the lamp to flash periodically. A more complex arrangement could involve a electroluminescent lamp that is divided into segments. In effect each segment functions as an independent electroluminescent lamp receiving a potential from the inverter and having a pattern of illumination that is determined by the control electronic circuit. The segments can be as small as desired in order to provide a display of any desired detail. The preferred electroluminescent lamp has a brightness of three hundred lumens. The wiring harness connects to the electroluminescent lamp through a hole that is formed in the laminated layers, and an additional hole in the envelop, where the lenticular display is affixed by way of the compartment embodiment.

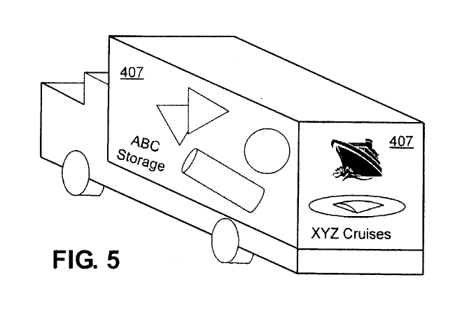

As illustrated by FIG. 4, an exemplary embodiment of the present application is now described. The lenticular sheet 407 is rotatably mounted between a conveyer system 409. In one embodiment, the lenticular sheet 407 has printed images, the lenticular sheet advantageously move in a particular direction 405 as guided by the conveyer system 409. In another embodiment, not shown, the images are printed on another sheet inserted adjacent to the lenticular sheet 407 and a electroluminescent panel 411, where the another sheet rotatably moves with the conveyer system 409 while the lenticular sheet remain stationary. Alternatively, the images are printed on the electroluminescent panels 411 while the lenticular sheet 407 rotatably moves with the conveyer system 409.

The speed, frequency, and direction of the movement of the conveyer 409 is controlled by a Conveyer Control System 401. The movement maybe one or more of continuous motion, periodic motion, or sporadic motion. This system may be implemented at local or remote locations by a combination of electro-mechanical system including a computerized system 401 controlling the conveyer assembly 409. In one embodiment, during operation of the system 400, the electroluminescent panel automatically shines light 417 upon the lenticular sheet 407 depending on degree and strength of the ambient light of the surrounding the system. Advantageously, sensors embedded within electroluminescent panel provides feedback to the conveyer control system, which in turn controls the power to the electroluminescent panel 411 when certain ambient conditions are meet. The ambient conditions include strength of the lighting conditions of the surrounding are around system 400.

Additional movement maybe introduced to the system by the position of the viewer 413. In one embodiment, the viewer may stay stationary while the another sheet or lenticular sheet 407 are rotatably moved through the conveyer system 409. In another embodiment, the viewer may move in a plurality of directions, 415 and 416, respectively. The movement speed and direction for all moving parts in the conveyer system may be substantially the same or different depending on the configuration of the system. In one embodiment, the lenticular sheet or the another sheet may move as the viewer 413 moves, in particular, the electroluminescent panels can support motion tracking sensors to keep track of a viewer moving across the lenticular sheet. The system automatically adjusts the rotation speed and direction of the conveyer as to show a image or a sequence of images for that particular viewer.

In one exemplary embodiment, as the viewer is moved in direction 415, and the lenticular sheet moves in direction 405, the viewer will see a presentation of a series of related images for a particular product if the images are related to one particular product. Advantageously, advertisers for a particular product may use a plurality of images to create a short motional sequence such as a 30 second motion picture based on the plurality of images related to the product and the movement introduced by the viewer 413 and/or conveyer system 409. In an alternative embodiment, the advertisers may place different unrelated products images in system 400. As the viewing angle changes due to movement of lenticular sheet 407 and/or viewer 413, the viewer advantageously perceives different images. The embodiments of FIG. 4 maybe mounted on a plurality of structures, including on surface of trucks or buildings as shown in FIG. 5.

While the invention has been described with reference to preferred embodiments, those skilled in the art will appreciate that certain substitutions, alterations and omissions may be made to the embodiments without departing from the spirit of the invention. For example, the battery and inverter can be replaced by a cord and plug for AC operation for energizing the lamp only when the wearable article is stationary or only being moved within the length of the cord and any extension cord that maybe used. This can also be used when the lamp is only to be energized temporarily. Of course, the advantages of battery operation enable the display to be moved or transported while the lenticular is illuminated. Accordingly, the foregoing description is meant to be exemplary only, and should not limit the scope of the invention.

What is claimed is:

1. A lenticular display comprising:
a lenticular sheet having a plurality of lenticules and a rear surface;
at least one image positioned adjacent to the rear surface of the lenticular sheet which is viewed through the lenticular; and
a conveyer system for changing the at least one image.

2. The lenticular display of claim 1, further comprises an electroluminescent panel to illuminate the at least one image for display.

3. The lenticular display of claim 1, wherein the at least one image is printed on a separate sheet which is moved by the conveyer to change the at least one image.

4. The lenticular display of claim 1, wherein the at least one image is printed on the lenticular sheet, and wherein the lenticular sheet is moved by the conveyer to change the at least one image.

5. A lenticular display comprising:
a lenticular sheet having a plurality of lenticules and a rear surface;
a plurality of interlaced images positioned adjacent to the rear surface of the lenticular sheet; and
a electroluminescent panel to illuminate the image(s) for display;
wherein the interlaced images are individually viewable at a different angles with respect to the display and comprise commercial advertising of one or more products,
and further wherein the images display a sequence of images relating to one product, or wherein different images display different products.

6. The lenticular display of claim 5, where the images are printed on a separate sheet.

7. The lenticular display of claim 5, where the images are printed on the back of the lenticular sheet.

8. The lenticular display of claim 5, where the images are printed on said electroluminescent panel.

9. The lenticular display of claim 5, wherein the images have a resolution of between 300 dpi and 800 dpi.

10. The lenticular display of claim 5, wherein the images provide the appearance of movement.

11. A lenticular display comprising:
a lenticular sheet having a plurality of lenticules and a rear surface;
one or more image(s) printed on a first display region of the rear surface of the lenticular sheet;
a substantially opaque border printed on a second display region of the rear surface of the lenticular sheet surrounding the first display region; and
a housing supporting the lenticular sheet;
wherein the opaque border provides the appearance of a raised mat around the image(s) on the first display region.

12. The lenticular display of claim 11, wherein the second display region includes at least one interlaced image printed therein, wherein a substantially opaque third display region is printed on the rear surface of the lenticular sheet between the first and second display regions, so as to create a bevel affect between the first and second display regions to further enhance the appearance of the border.

13. The lenticular display of claim 11, which further comprises an electroluminescent panel that illuminates the image(s) to provide greater visibility and an enhanced appearance to the image(s).

14. A combination comprising:
a lenticular display that includes a lenticular sheet having a plurality of lenticules and a rear surface;
at least one image printed on a first display region of the rear surface of the lenticular sheet; and
a vehicle that includes a support for mounting the sheet and images, so that the display can be transported and viewed during movement of the vehicle.

15. The combination of claim 14, wherein the lenticular display includes an electroluminescent panel that provides backlight illumination of the display.

16. The combination of claim 15 wherein the electroluminescent panel is powered by a battery.

17. The combination of claim 15, wherein the electroluminescent panel is operatively associated with a sensor that detects darkness or motion for powering the panel only when movement or darkness is sensed by the sensor.

18. The combination of claim 15, wherein the at least one image comprises a plurality of interlaced images which are individually viewable at a different angles with respect to the display.
